(19) United States
(12) Patent Application Publication
(10) Pub. No.: US 2005/0249492 A1
(43) Pub. Date: Nov. 10, 2005

(54) DUAL CAMERA HELMET MOUNT

(76) Inventor: Anthony J. Metcalf, Kalamazoo, MI (US)

Correspondence Address: GEOFFREY E. DOBBIN, PATENT ATTORNEY, 4278 SOUTH 6220 WEST, WEST VALLEY CITY, UT, 84128-6501, US

(21) Appl. No.: 10/908,294

(22) Filed: May 5, 2005

Related U.S. Application Data
(60) Provisional application No. 60/521,487, filed on May 5, 2004.

(51) Int. Cl. G03B 17/00

(52) U.S. Cl. 396/420

(57) ABSTRACT

The present invention is a dual camera side helmet mount having a mount body divided into two containment compartments. Angular adjustment of the mount relative to the helmet is possible by means of the mounting interface of the mount with the helmet. Each compartment is designed to carry one camera and will carry said cameras in a low profile manner such that each camera's line of sight is proximate the line of sight of the user's eyes.

### CROSS-REFERENCES TO RELATED APPLICATIONS

This application is a perfection of and claims priority based on prior provisional application No. 60/521,487, filed on May 5, 2004.

### FIELD OF INVENTION

The present invention relates to camera mounts and more particularly relates to a camera mount that supports both a video camera and a still camera while in turn being supported on a side of a user's helmet.

### BACKGROUND OF THE INVENTION

Camera mounts are known in the prior art and are used generally for securing a camera to a stable object so that a user need not hold the camera with hands. Currently, one common type of camera mount is located on a helmet of a user engaged in an athletic activity. Camera mounts in the prior art tend to only hold one camera. This is mainly because of size limitations. As cameras have gotten smaller, especially video cameras, dual camera mounts are being developed. Until now, dual camera helmet mounts have been integral parts of the top of the helmet. Being positioned at the top of the helmet does present a disadvantage, however, during certain activities, as such a mount may cause interference. One such activity is skydiving, where larger cameras positioned on the top of the helmet do present an increased risk of snagging a parachute. What is needed, then, is a low profile camera mount located on another, less prominent, location, such as the side of the helmet.

While the aforementioned helmet mounts accomplish their individual objectives, they do not describe a helmet mount for two different cameras mountable on the side of the helmet. Side mounting is desirable as there is less chance of interference. It requires, however, low profile and low weight for the comfort of the user. The cameras must also be mounted so that both capture the line of sight of the user. This type of mount is made possible, as cameras, especially video cameras, have gotten smaller over time. In this respect, the camera mount according to the present invention departs substantially from the usual designs in the prior art. In doing so, this invention provides a low profile, side mounted camera mount capable of simultaneously holding a both video camera and a still camera.

### SUMMARY OF THE INVENTION

In view of the foregoing disadvantages inherent in the known types of helmet camera mounts, this invention provides an improved side mounted camera mount. As such, the present invention's general purpose is to provide a new and improved camera mount that will mount both a video and a still camera on the side of the user's helmet.

To accomplish this goal, the camera mount essentially comprises an adjustable interface with a mount body. The interface allows the angle of the cameras to be adjusted for the user's line of sight. The mount features a back and a floor at a generally right angle and defining a volume. A dividing wall is perpendicular to both and divides the volume into two compartments, one for each camera. Standard camera mount bolts and additional securement straps are provided.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a bottom perspective view of the present invention.

FIG. 2 is a top perspective view of the present invention.

FIG. 3 is a side elevation of the present invention, detailing the arcuate adjustment slots.

### DETAILED DESCRIPTION OF THE PREFERRED EMBODIMENT

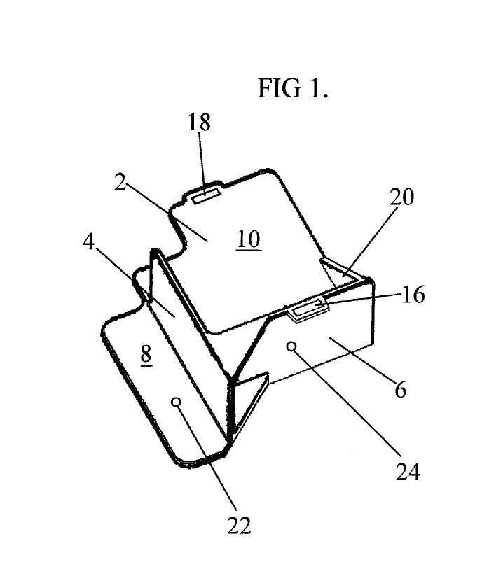

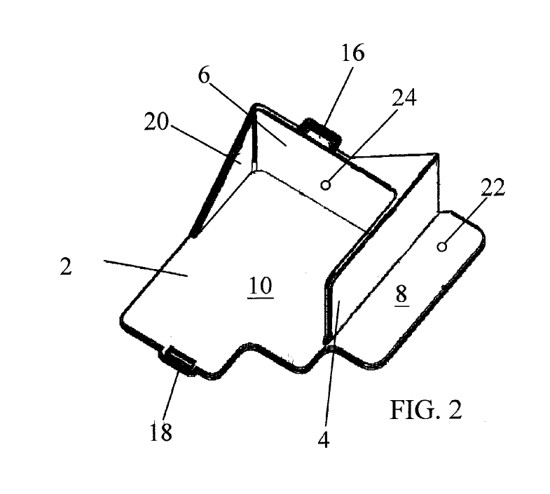

With reference now to the drawings, the preferred embodiment of the camera mount is herein described. Referring to FIGS. 1 and 2, the mount has a mount back 2 as its primary component. Extending perpendicularly from mount back 2 is mount wall 4, which defines two chambers 8, 10, for holding cameras. A floor 6, likewise perpendicular to mount back 2, is also provided for additional camera support and securement. Rib 20 may also be provided to further define chamber 10, and provide psychological security, but is unnecessary for proper functioning of the mount as cameras are secured with straps and custom drilled camera mount holes 22, 24.

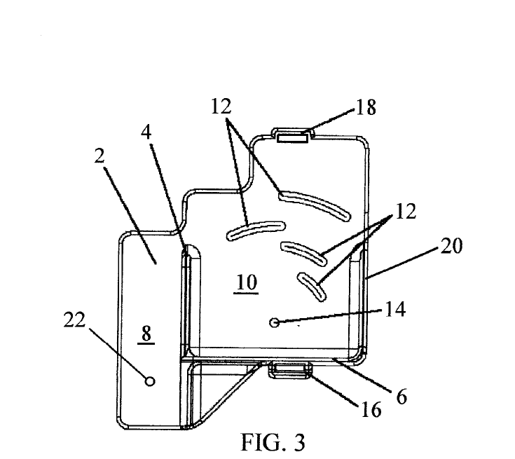

Mount back 2 ideally should have a at least one arcuate slot 12, shown in FIG. 3, with a plurality at different radial distances from a pivot hole 14, being preferred, for angular adjustment of the mount. In use, mount back 2 is fastened to a helmet by bolts passed through at least one arcuate slot 12 and pivot hole 14. The bolt in arcuate slot 12 is loosened to provide angular adjustment of the mount about pivot hole 14 and is tightened when such adjustment is achieved. A video camera is placed in chamber 10 and secured by utilizing a tripod bolt interface and a strap. The hole 24 for the bolt interface is ideally bored through the floor 6 or mount back 2 at the direction of the end user, as interface points vary on different camera models. A strap is attached to the mount at strap anchors 16, 18. Chamber 8 receives a still camera, ideally either a 35 mm or a digital camera. This second camera is positioned underneath the video camera lens and is secured by means similar as the video camera, i.e. a tripod bolt interface which is secured through a hole 22 drilled in either the mount wall 4 or mount back 2 at the direction of the end user. The resultant relative positioning of the cameras provide a compact, low overall volume presentation and virtually identical lines of sight as compared to each other and the user's eyes.

Although the present invention has been described with reference to preferred embodiments, numerous modifications and variations can be made and still the result will come within the scope of the invention. It is to be understood that the end user will direct the positioning of securement holes to accommodate the end user's cameras. As such, the holes 22, 24 may be drilled in any solid feature of the mount, particularly mount back 2, mount wall 4, floor 6, or rib 20, and the present invention will still be practiced irrespective of the location of the securement holes 22, 24. It should also be noted that dimensions of the holder must vary between holder models in order to accommodate different camera models. No limitation with respect to the specific embodiments disclosed herein is intended or should be inferred.

1. A dual camera side helmet mount comprising:
a mount back;
a mount wall, generally perpendicular to the mount back;
at least one mount floor, likewise generally perpendicular to the mount back; and
means of securing at least one camera to the helmet mount;
wherein, the mount back, mount wall and mount floor together define two camera chambers, each chamber capable of receiving a camera.

2. The camera mount of claim 1, further comprising an angular adjustment means.

3. The helmet mount of claim 2, the angular adjustment means is at least one arcuate slot in the mount back.

4. The helmet mount of claim 3, the means of securing at least one camera to the mount further comprising at least one hole drilled into the helmet mount for receiving an attachment bolt.

5. The helmet mount of claim 4, the means of securing at least one camera to the mount further comprising at least one slot drilled into the helmet mount for receiving an attachment strap.

6. The helmet mount of claim 3, the means of securing at least one camera to the mount further comprising at least one slot drilled into the helmet mount for receiving an attachment strap.

7. The helmet mount of claim 2, the means of securing at least one camera to the mount further comprising at least one hole drilled into the helmet mount for receiving an attachment bolt.

8. The helmet mount of claim 7, the means of securing at least one camera to the mount further comprising at least one slot drilled into the helmet mount for receiving an attachment strap.

9. The helmet mount of claim 2, the means of securing at least one camera to the mount further comprising at least one slot drilled into the helmet mount for receiving an attachment strap.

10. The helmet mount of claim 1, the means of securing at least one camera to the mount further comprising at least one hole drilled into the helmet mount for receiving an attachment bolt.

11. The helmet mount of claim 10, the means of securing at least one camera to the mount further comprising at least one slot drilled into the helmet mount for receiving an attachment strap.

12. The helmet mount of claim 1, the means of securing at least one camera to the mount further comprising at least one slot drilled into the helmet mount for receiving an attachment strap.
